(19) United States
(12) Patent Application Publication
(10) Pub. No.: US 2009/0202098 A1
(43) Pub. Date: Aug. 13, 2009

(54) Occluding Earbud System and Method

(75) Inventors: Eric Chan, New York, NY (US); Diane Elabidi, Scotts Valley, CA (US); Bernice Cramer, Newton, MA (US); Gary Schultz, Andover, NJ (US)

Correspondence Address: PLANTRONICS, INC.;IP Department/Legal, 345 ENCINAL STREET, P.O. BOX 635, SANTA CRUZ, CA, 95060-0635, US

(73) Assignee: PLANTRONICS, INC.

(21) Appl. No.: 12/030,395

(22) Filed: Feb. 13, 2008

(51) Int. Cl. H04R 25/00

(52) U.S. Cl. 381/380

(57) ABSTRACT

An earbud is disclosed for use in a user's ear. The earbud includes an ear pad shaped to engage the concha of the ear and an audio driver coupled to the ear pad. When the earbud is installed in the user's ear the ear pad substantially occludes, or closes up the concha of the user's ear. Thus ambient noise is significantly attenuated before reaching the user's ear canal. Also, the earbud is supported primarily by the ear pad resting in the concha.

### FIELD OF THE INVENTION

The present invention relates generally to the field of ear buds, including those used with telephone communication.

### BACKGROUND OF THE INVENTION

Headphones include a pair of transducers that receive an electrical signal from a media player or receiver and are located in close proximity to the ears to convert the signal into audible sound waves. Earbuds are small headphones that are generally placed adjacent the ear canal. They are often favored for their portability and convenience. However, in some cases, due to their inability to provide significant acoustic isolation, they are not capable of delivering the precision and range of sound offered by many full-sized headphones. As a result, they are often used at higher volumes in order to drown out noise from the user's surroundings, which can increase the risk of hearing-loss. Earbuds have become a common component bundled with personal music devices such as the iPod and portable MP3 devices.

Canalphones, also known as in-ear monitors (IEMs), are earbuds that include a portion which sits inside the ear canal. Canalphones offer portability similar to other types of earbuds, and they often act as an earplug to block out environmental noise.

Turning now to FIG. 1, a conventional type of earbud or canalphone is shown. The earbud 10 includes and electrical cable 12 which is connected to a transducer 14. The transducer 14 is in turn connected to an earplug 16 which has a hole, not shown, through its center. A tube 20 connects the transducer 14 to the hole in the earplug 16 so that when the earplug 16 is mounted in a user's ear canal sound is conveyed from the transducer 14 through the tube 20 into the user's ear canal. The earplug 16 includes a rubber housing 22 surrounding the end of the tube 20 and a foam section 24 which contacts the user's ear canal.

To install the earbud shown in FIG. 1 the user compresses the foam section 24 and then inserts a portion of the foam section 24 into the user's ear canal. The foam is of a type sometimes called memory foam or slow recovery foam so that after it has been compressed it returns to its original shape and size slowly. Accordingly the user has the opportunity to place the foam section 24 in the ear canal while it is somewhat compressed and then the foam expands to fill the ear canal.

One disadvantage to this earbud 10 is that the user must force the foam section 24 into the ear canal which can be irritating or even painful. Moreover, after the earbud 10 is worn for an extended time the problem can become more severe since the weight of the device is completely supported by the user's ear canal. Also, it should be understood that although the foam section 24 is located inside the user's ear canal, the earbud 10 provides no other occlusion of the ear. Neither the transducer 14 nor any other part of the earbud 10 contacts the user's ear to effectively block noise from entering the ear canal. Since the foam section 24 can in some cases provide poor sound isolation, the user can be encouraged to increase the volume of the sound the user is listening to, thereby endangering the user's hearing.

Accordingly, it is desirable to have an earbud which is comfortable to wear and which has good sound isolation capability.

### BRIEF SUMMARY OF THE INVENTION

An embodiment of the present earbud includes an ear pad shaped to substantially occlude the concha of the ear and an audio transducer coupled to the ear pad. To install the earbud in the ear the user first compresses the ear pad so that the ear pad can enter the ear. The user then insets the earbud into place. The ear pad is formed of a slow recovery foam material, so that while the user is placing the ear pad in the ear the ear pad is slowly returning to its original configuration. While this is occurring the user holds the earbud in place until it has expanded sufficiently to hold itself in place.

When the earbud is installed in the user's ear the ear pad substantially occludes, or closes up the concha of the user's ear. Thus ambient noise is significantly attenuated before reaching the user's ear canal. Also, the earbud is supported primarily by the ear pad resting in the concha.

Further features and advantages of the present invention, as well as the structure and operation of the above-summarized and other exemplary embodiments of the invention, are described in detail below with respect to accompanying drawings, in which like reference numbers are used to indicate identical or functionally similar elements.

### BRIEF DESCRIPTION OF THE DRAWINGS

FIG. 1 illustrates a conventional ear bud system;

FIG. 2 is a photograph of an ear;

FIG. 3 is another illustration of an ear;

FIG. 4 illustrates an embodiment of the present earbud located in an ear;

FIG. 5 is a schematic, cross-sectional, exploded illustration of a portion of the embodiment of the earbud of FIG. 4;

FIG. 6 is another schematic, cross-sectional, exploded illustration of a portion of the embodiment of the earbud of FIG. 4;

FIG. 7 is a top view of a portion of the present earbud;

FIG. 8 is a side view of a portion of the present earbud;

FIG. 9 is an end view of a portion of the present earbud;

FIG. 10 is a bottom view of a portion of the present earbud;

FIG. 11 is a dimensioned top view of a portion of the present earbud;

FIG. 12 is a dimensioned side view of a portion of the present earbud;

FIG. 13 is a dimensioned end view of a portion of the present earbud; and,

FIG. 14 shows a portion of an alternative embodiment of an earbud.

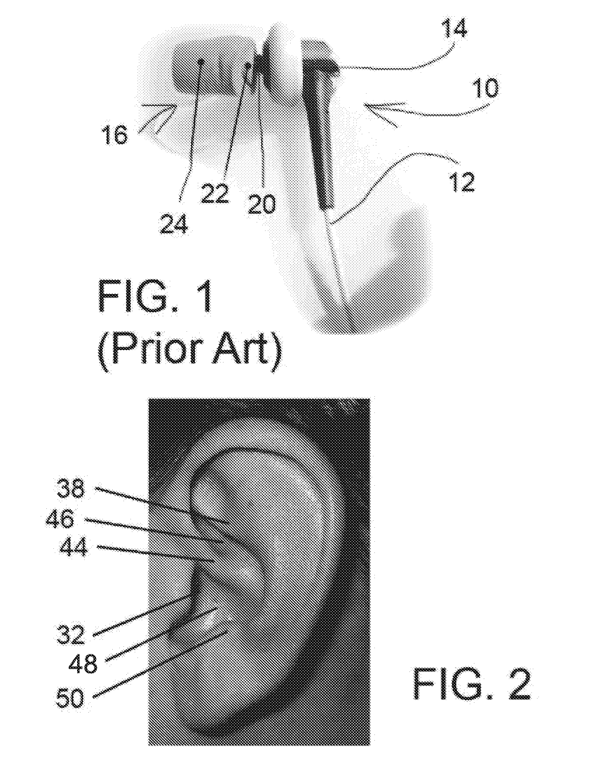

### DETAILED DESCRIPTION

Embodiments of the present invention are described herein. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

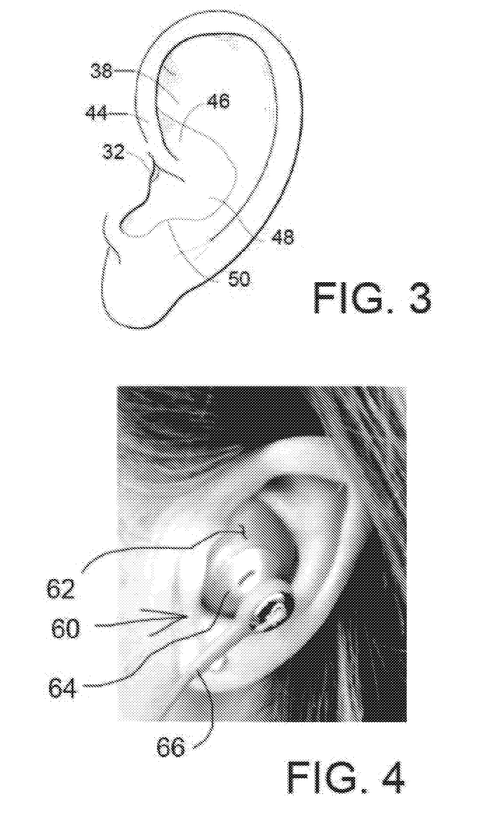

With reference to FIGS. 2 and 3, parts of a left ear 28 are identified. The ear includes meatus acusticus externus 32, crus inferius anthelicus 38, crus helicis 44, cymba concha 46, cavum concha 48, and antitragus 50. The cymba concha 46 and the cavum concha 48 can together be considered the concha.

With reference to FIGS. 4-13 an embodiment of the present earbud is shown. In FIG. 4 the earbud 60 is shown installed in a user's ear. The earbud 60 includes an ear pad 62 and an audio driver 64 coupled to the earpad 62, and electrical wiring 66 is connected to the audio driver 64.

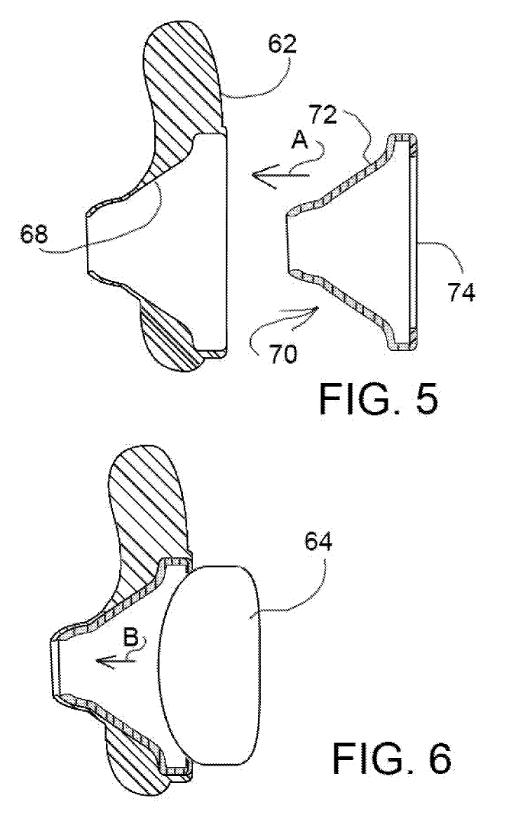

With reference now to FIGS. 5 and 6 the earbud 60 is shown partially disassembled and in cross section. The ear pad 62 includes a hole 68 which is generally frusto-conical in shape. A driver housing 70 is hollow with a generally frusto-conical shape and is formed of rubber and mounted in the ear pad 62 as indicated by arrow A. The ear pad 62 is formed of foam of a type which is often called memory foam or slow recovery foam such as is taught in U.S. Pat. No. 4,253,452 titled “Ear Plug Assembly”.

The audio driver 64 is mounted in the driver housing 70. The audio driver includes an electronic speaker which receives electrical signals and converts them to audible sound which is directed toward the left as indicated by arrow B in FIG. 6. Details of the audio driver 64 are conventional and therefore will not be discussed in detail herein.

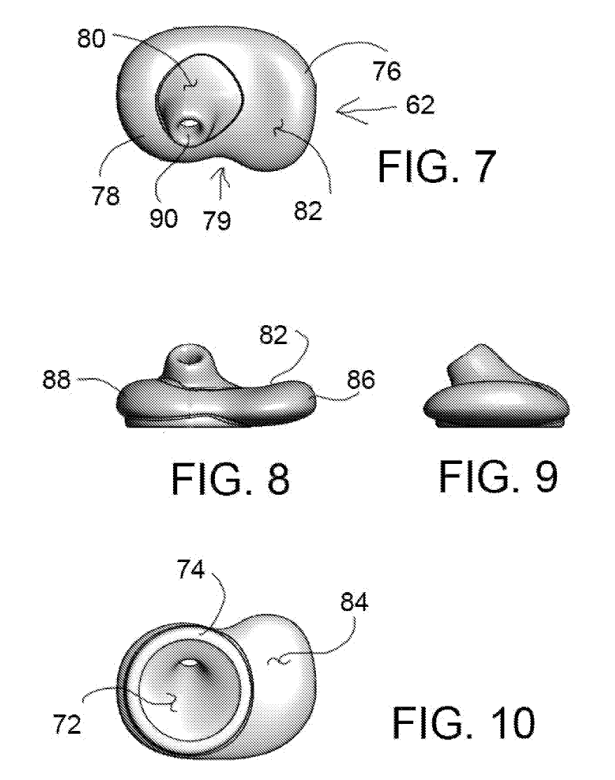

FIGS. 7-10 are views of the ear pad 62 and driver housing 70, namely, top view, side view, end view and bottom view respectively. The ear pad 62 has first and second sides 82 and 84 and first and second ends 86 and 88 respectively. It should be understood that the illustrated earpad 62 is intended to be used in the user's left ear, and for the right ear the earpad, not shown, is substantially the same except it is a mirror image of the illustrated earpad 62. The earpad 62 includes a first lobe 76, a second lobe 78 and a transition section 79 connecting the two lobes 76 and 78. An insertion member 80 is connected to the ear pad 62 and located between the first lobe 76 and the second lobe 78. When inserted in the ear the first end 86 is above the second end 88 and the first side 82 is proximal the user's ear while the second side 84 is distal thereof.

The insertion member 80 has a substantially frusto-conical shape and is configured to fit adjacent the user's ear canal without contacting the ear canal. The driver housing 70 is mounted in the insertion member 80, and the driver housing 70 includes a substantially frusto-conical section 72 and a ring-shaped section 74. A hole 90 is formed through the center of the driver housing 70 to carry sound between the audio driver 64 and the user's ear canal.

The first lobe 76 is shaped to substantially conform to the cymba concha 46 of the user's ear, and the second lobe 78 is shaped to substantially conform to the cavum concha 48 of the user's ear.

The first lobe 76 is shaped so that when the earbud is installed in the user's ear as shown in FIG. 4 at least a portion of the lobe 76 contacts at least a portion of the cymba concha 46 which is located between the crus inferius anthelicus 38 and the cymba concha 46. The portion of the lobe 76 which contacts at least a portion of the cymba concha 46 which is located between the crus inferius anthelicus 38 and the cymba concha 46 can be considered to be a crus inferius anthelicus section. For the purposes of this description, and as best seen in FIG. 2, it should be understood that the cymba concha 46 is an indentation above the radix helicis 44, and the crus inferius anthelicus 38 is a fold-like structure located farther from the user's head than the cymba concha 46. Thus the portion of the cymba concha 46 which is located between the crus inferius anthelicus 38 and the cymba concha 46 can be understood to be nearer the user's head (i.e. proximal the user's head) than other portions of the crus inferius anthelicus 38 which can be considered more distal of the user's head.

The second lobe 78 is shaped so that when the earbud is installed in the user's ear as shown in FIG. 4 at least a portion of the second lobe 78 contacts at least a portion of the cavum concha 48 which is located between the antitragus 50 and the cavum concha 48. The portion of the second lobe 78 which contacts at least a portion of the cavum concha 48 which is located between the antitragus 50 and the cavum concha 48 can be considered to be an antitragus section. For the purposes of this description, and as best seen in FIG. 2, it should be understood that the cavum concha 48 is a generally cup-like structure and the antitragus 50 is a bulb-like structure located farther from the user's head than the cavum concha. Thus the portion of the cavum concha 48 which is located between the antitragus 50 and the cavum concha 48 can be understood to be nearer the user's head (i.e. proximal the user's head) than other portions of the antitragus 50 which can be considered more distal of the user's head.

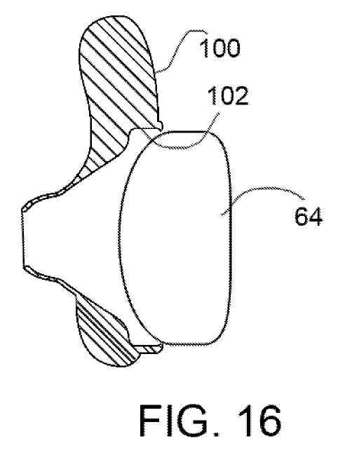

Turning now to FIGS. 14-15 it can be seen that lines have been added to the drawings for the purpose of aiding the following description of certain features of the ear pad 62. Also, for the purposes of explanation an X-Y-Z coordinate system is shown which corresponds to the ear pad 62 in the orientation shown in FIGS. 12 and 14. Line 100 represents the edge of a first flat surface on which the lower side of the ring-shaped section 74 is resting, and lines 102 and 103 represent the edges of a second flat surface and a third flat surface which are parallel to the first surface 100. The line 103 is tangent to a second convex portion 104 of the second lobe 78, and the line 103 is also tangent to a first convex portion 106 of the first lobe 76. Between the first convex portion 106 and the second convex portion 104 the first side 82 forms a smooth arcuate section which dips downward in the Y direction to form a first concave portion 110. At its lowest point the first concave portion 110 is a maximum of about 3.5 millimeters below line 103.

Line 102 runs through a third convex portion 112 of first lobe and 76 a fourth convex portion 114 of second lobe 78 at the elevation at which the outer edge of the third convex portion 112 and the fourth convex portion 114 are spaced apart from each other the maximum distance, namely 27 millimeters in the presently illustrated embodiment. It can be noted that the first lobe 76 includes a fifth convex portion 116, and a sixth convex portion 118 is located between the first lobe 76 and second lobe 78.

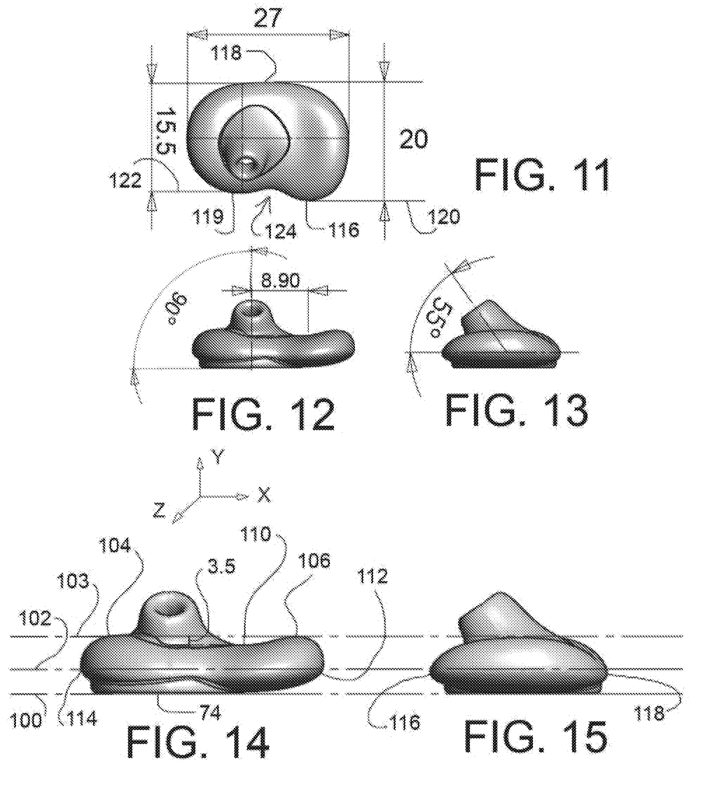

Turning again to FIG. 11 it can be noted that line 120 is tangent to the fifth convex portion 116 of first lobe 76 and line 122 is tangent to a seventh convex portion 119 of second lobe 78. Line 120 is parallel to line 122 and the two lines a spaced apart from each other about 4.5 millimeters in the Z direction. Between the fifth convex portion 116 of first lobe 76 and seventh convex portion 119 of second lobe 78 a smooth arcuate section is formed which curves upward in the Z direction to form a second concave portion 124. In the Z direction the maximum distance between the second concave portion 124 and line 120 is about 2.25 millimeters.

With reference now to FIGS. 11 - 13 dimensions of the ear pad 62 are shown in millimeters. It should be noted that the maximum width of the first lobe 76 is about 20 mm, which is significantly greater than the maximum width of the second lobe 78 which is 15.5 mm.

The operation of the present earbud 60 can now be understood. To install the earbud 60 in the ear the user first compresses the ear pad 62. The exact nature of the compression can vary between users, but generally speaking a user compresses the first end 86 toward the second end 88 so that the ear pad 62 can enter the ear. The user then insets the earbud into place as shown in FIG. 4 with the insertion member 80 in the user's acusticus externus 32. Since the ear pad 62 is formed of a slow recovery foam material, while the user is placing the ear pad 62 in the ear the ear pad 62 is slowly returning to its original configuration. While this is occurring the user holds the earbud in place until it has expanded sufficiently to hold itself in place.

It should now be understood that when the earbud 60 is installed in the user's ear the ear pad 62 substantially occludes, or closes up the concha of the user's ear. The first lobe 76 substantially occludes the cymba concha 46, and the second lobe 78 substantially occludes the cavum concha 48. Thus ambient noise is significantly attenuated before reaching the user's ear canal (meatus acusticus externus 32). Also, the earbud 60 is supported primarily by the second lobe 78 of the ear pad 62 resting in the portion of the cavum concha 48 which is located between the antitragus 50 and the cavum concha 48. Furthermore, the earbud is retained in the user's ear in part by the portion of the first lobe 76 which contacts at least a portion of the cymba concha 46 which is located between the crus inferius anthelicus 38 and the cymba concha 46.

Turning now to FIG. 14, an alternative embodiment is illustrated. This alternative embodiment is similar to the embodiment described above, with the exception that in the FIG. 14 embodiment the ear pad 100 is formed of silicone foam rather than slow recovery foam. We have found that silicone foam having a Shore durometer of about 18-30 HA is preferable. In this embodiment there is no driver housing comparable to driver housing 70 of the first embodiment, described above. In the FIG. 14 embodiment the audio driver 64 is mounted directly in a hole 102 formed in the ear pad 100. This difference between the two embodiments is due to the fact that the slow recovery foam of ear pad 62 is more flexible than the silicone foam of the ear pad 100. Accordingly the driver housing 70 is necessary to retain the audio driver 64 in the ear pad 62 but not in the ear pad 100.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. Accordingly, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. An earbud for use in a user's ear which has a concha, the earbud comprising:
an ear pad shaped to engage the concha of the ear; and,
an audio driver coupled to said ear pad.

2. An earbud according to claim 1 wherein said ear pad comprises a first section constructed and arranged to substantially occlude the cymba concha.

3. An earbud according to claim 2 wherein said first section of said ear pad comprises a crus inferius anthelicus section constructed and arranged to contact a portion of the cymba concha proximal of the crus inferius anthelicus of the user's ear.

4. An earbud according to claim 1 wherein said ear pad comprises:
a second section constructed and arranged to substantially occlude the cavum concha.

5. An earbud according to claim 4 wherein said second section of said ear pad comprises an antitragus section constructed and arranged to contact a portion of the cavum concha proximal of the antitragus of the user's ear.

6. An earbud for use in a user's ear, the earbud comprising:
an ear pad shaped to conform to the concha of the ear; and,
an audio driver coupled to said ear pad.

7. An earbud according to claim 6 wherein said ear pad comprises a first lobe and a second lobe.

8. An earbud according to claim 7 wherein said first lobe is shaped to substantially conform to the cymba concha.

9. An earbud according to claim 7 wherein said second lobe is shaped to substantially conform to the cavum concha.

10. An earbud according to claim 6 wherein said ear pad further comprises a driver housing.

11. An earbud according to claim 10 wherein said driver housing is constructed and arranged to substantially conform to the meatus acusticus externus.

12. An earbud according to claim 10 wherein said driver housing has a substantially frusto-conical shape.

13. An earbud according to claim 6 wherein said ear pad comprises an insertion member.

14. An earbud according to claim 13 wherein said insertion member is constructed and arranged to substantially conform to the meatus acusticus externus.

15. An earbud according to claim 13 wherein said insertion member has a substantially frusto-conical shape.

16. An earbud for use in a user's ear, the earbud comprising:
a base having a first lobe and a second lobe;
an insertion member coupled to said base; and,
an audio driver coupled to said base.

17. An earbud according to claim 16 wherein said first lobe is coupled to said second lobe by a transition section.

18. An earbud according to claim 16 wherein said first lobe has a proximal side and a distal side, and the proximal side is substantially flat.

19. An earbud according to claim 16 wherein said insertion member is substantially frusto-conical in configuration with a central axis, and the central axis of said insertion member is substantially perpendicular to the proximal side of said first lobe in a first dimension.

20. An earbud according to claim 19 wherein the central axis of said insertion member is oriented at about 55 degrees relative to the proximal side of said first lobe in a second dimension.

21. A method for inserting an earbud in a user's ear, wherein the earbud includes a base, the method comprising:
compressing the base so that it is smaller than the concha of the user's ear;
inserting the base into the concha of the user's ear; and,
holding the base in the concha a sufficient time to allow the base to expand until it is retained in the concha.

22. A method according to claim 21 wherein the earbud further comprises an insertion member and the method further comprises inserting the insertion member adjacent the user's meatus acusticus externus.

23. A method according to claim 21 wherein when the earbud is retained in the concha, a section of the base contacts a portion of the cavum concha proximal of the tragus of the user's ear.

24. A method according to claim 21 wherein when the earbud is retained in the concha, a section of the base contacts a portion of the cymba concha proximal of the crus inferius anthelicus of the user's ear.

25. A method according to claim 21 wherein when the earbud is retained in the concha, a section of the base contacts a portion of the cavum concha proximal of the antitragus of the user's ear.
